(19) United States
(12) Patent Application Publication
(10) Pub. No.: US 2005/0038729 A1
(43) Pub. Date: Feb. 17, 2005

(54) Method and system for monitoring volume information in stock market

(75) Inventors: Yen-Tseng Hsu, Taipei City (TW); Chien-Ming Chen, Taipei City (TW); Jerome Yeh, Taipei County (TW)

Correspondence Address: BACON & THOMAS, PLLC, 625 SLATERS LANE, FOURTH FLOOR, ALEXANDRIA, VA, 22314, US

(73) Assignee: Gofaser Technology Company, Taipei City (TW)

(21) Appl. No.: 10/639,466

(22) Filed: Aug. 13, 2003

(51) Int. Cl. G06F 17/60

(52) U.S. Cl. 705/37

(57) ABSTRACT

An information monitoring method is provided which may track and monitor specific events of changing input data, such as stock market information, and notify venture capitalists or investors in real time of the occurrence of identified events of interest. According to the method to train or learn the quantitative patterns inherent in data sets, such as correlation between MAP and MAV, the relationship based on rules is built. A gray coefficient, trained by neural network under the specific events occurred in the historical data, is obtained for tracking and monitoring the present input data in real time. Artificial intelligence is therefore provided permitting adaptive monitoring of the input data in present invention.

### BACKGROUND OF THE INVENTION

This invention relates in general to a method and system for monitoring stock market information with investment risk, and related in particular to a method and system for monitoring the specific events of current volume data in stock market information and notifying venture capitalists or investors in real time of the occurrence of identified events of interest.

Traditionally, investing in stock market has been difficult for the typical individual investor, particularly when the investor wishes to invest in a number of different investments but has a limited amount of funds to invest. The problem is exacerbated by the fact that most individual investors have neither the understanding nor the resources to properly measure the risk of investments.

Considering investment in stocks as illustrative of the general problem posed above, the advent of stock mutual funds in recent years has made it substantially easier for the individual investor to achieve the goal of diversification on a limited budget. The fact that a fund manager assumes the responsibility, which would otherwise be the investor's, of researching and trading the stocks of individual companies has contributed significantly to the widespread popularity of mutual funds as a convenient vehicle for investing in the stock market.

Elliott Wave Principle forecasting is a famous technical analysis of stock trends, which is also a complex and unfathomable analysis method for most individual investors. Common investor just knows roughly that the wave formation has five distinct price movements, three in the direction of the trend and two against the trend. If the investor wants to obtain higher accurate forecasting in the stock market, he has to understand completely all rules of Elliott Wave Principle. Otherwise, he might make a wrong analysis. Thus, it is a very difficult to understand all of the rules unless he is a professional analyst for Elliott Wave Principle forecasting.

Because much information have to analysis in the investment of stock market, a stock market which reflects the actions and emotions of investors caused by exterior influences or mass psychology is an information system rather than an economic system. The stock market information comprise KD, MACD, RSI, sales volume, daily chart, weekly chart, monthly chart, . . . , and so on. How do individual investors deal with the huge stock market information? Although various information services have long existed for distributing information pertaining to daily activities in the various financial markets, such services are of little use to the average investor who does not have the time to continuously monitor the received information. As a result, large investors, and those who can afford the continuous monitoring services of investment brokers, have typically had an advantage in market investments. Such an AI-processing computer system dedicated to process the stock market information will be good for the investors to do a decision-making investment in the stock market.

In the prior art of AI-processing computer system or expert system, the “human intelligence” or “human experience” are usually represented in a knowledge database or a rule-based database. These knowledge or rules built in the database are used for monitoring and ruling the specific events of changing input data to produce the inference in the application filed. In the development of neural networks, U.S. Pat. No. 5,222,194 issued Jun. 22, 1993 discloses a neural network computation. After learning examples, a mutual operation between a logical knowledge and a pattern recognizing performance can be accomplished and thereby a determination close to that of a specialist can be accomplished.

Accordingly, the present invention discloses a monitoring method and system for evaluating stock market information with a neural network computation in used of such AI-processing computer system or expert system to deal with unknown patterns in the stock market information.

### SUMMARY OF THE INVENTION

In view of the foregoing, an object of this invention is to provide a monitoring method and system for tracing and monitoring the unknown patterns of current volume data in the stock market information to indicate the occurrence of identified events of interest, such a top period of bull trend or a bottom period of bear trend.

An another object of the present invention is to provide a computer-implemented process for tracing and monitoring the changing volume data in the stock market information in used of such AI-processing computer system or expert system.

In one preferred embodiment of the present invention, based on the historical stock prices and volumes in the stock market information, the method of present invention extracts top periods of price in a bull trend to find corresponding top volumes and bottom periods of price in a bear trend to find corresponding bottom volumes. Under a supervised learning mode, a neural network is used to train or learn the quantitative patterns inherent in data sets of price and volume in a bull trend, such as correlation between moving average price (MAP) and moving average volume (MAV), the relationship based on rules is built. A gray coefficient, trained by neural network under the specific events occurred in the historical bear trend, is obtained for tracking and monitoring the current volume data to determine whether a bear bottom in a bear trend appears to be the way the current volume fell within a volume range defined by the historical correlation between the stock price and volume, under the stock price is in the bear trend.

In another preferred embodiment of the present invention, based on the historical stock prices and volumes in the stock market information, the method of present invention extracts top periods of price in a bull trend to find corresponding top volumes and bottom periods of price in a bear trend to find corresponding bottom volumes. Under a supervised learning mode, a neural network is used to train or learn the quantitative patterns inherent in data sets of price and volume in a bear trend, such as correlation between moving average price (MAP) and moving average volume (MAV), the relationship based on rules is built. A gray coefficient, trained by neural network under the specific events occurred in the historical bull trend, is obtained for tracking and monitoring the current volume data to determine whether a bull top in a bull trend appears to be the way current volume fell within a volume range defined by the historical correlation between the stock price and volume, under the stock price is in the bull trend.

### BRIEF DESCRIPTION OF THE DRAWINGS

The following detailed description of preferred embodiments of the present invention would be better understood when read in conjunction with the appended drawings. For the purpose of illustrating the present invention, there is shown in the drawings embodiments which are presently preferred. However, the present invention is not limited to the precise arrangements and instrumentalities shown. In the drawings:

FIG. 1 is a trend diagram comprising price and corresponding volume in the stock market information.

FIG. 2 is a schematic diagram illustrating a top period of price in a bull trend and a corresponding top volume according to the present invention.

FIG. 3 is a schematic diagram illustrating a bottom period of price in a bear trend and a corresponding bottom volume according to the present invention.

FIG. 4 is a flowchart of the first embodiment of the present invention.

FIG. 5 is a flowchart of the second embodiment of the present invention.

### DETAILED DESCRIPTION OF PREFERRED EMBODIMENT

Certain terminology is used herein for convenience only and is not to be taken as a limitation on the present invention.

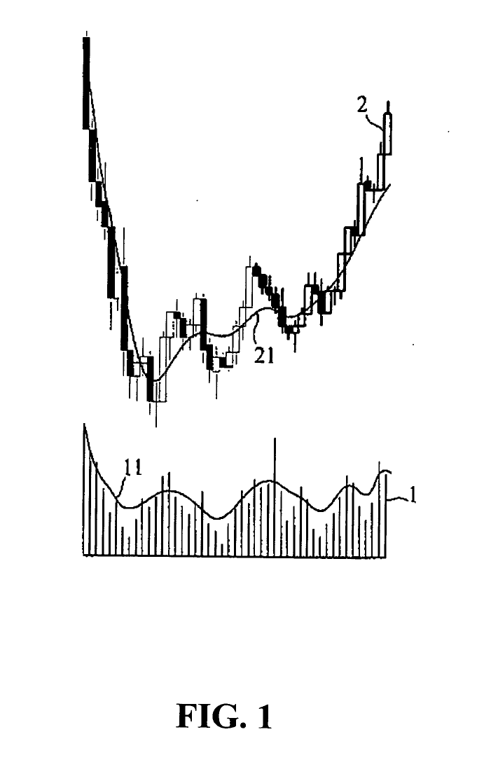

FIG. 1 illustrates a trend diagram comprising price and corresponding volume in the stock market information. The correlation between stock price and corresponding volume in a stock market information is an important information for each individual investor. The Price and Volume Trend (PVT) is a cumulative total of volume adjusted according to relative changes in closing prices, used to determine the strength of trends and warn of reversals. A rising PVT confirms an up-trend and a falling PVT confirms a down-trend.

In the trend diagram shown in FIG. 1, stock price and volume are corresponding each other. According to the observation of different time axes, there are daily trend, weekly trend and monthly trend diagrams. However, the information of the best interest by investors is a top period and a bottom period of stock price trend in FIG. 1. Because a bull market starts when a bottom period of a bear trend is confirmed and a bear market commences when a top period of a bull trend is confirmed. The top and bottom forms of trend have often responded to the changing volume. Investors are difficult to find the correlation of technical analysis from huge amount of data in a stock market information, and to observe immediately the symptoms to form top and bottom of trend by the way of individual experiences.

In one preferred embodiment, the AI-processing method of present invention, based on the historical stock prices and volumes in the stock market information, extracts top periods and bottom periods of price trend so as to distinguish a bear trend from a top period toward a bottom period and a bull trend from a bottom period toward a top period. According to the top periods and bottom periods, corresponding top volumes and corresponding bottom volumes are easily obtained from PVT. A neural network with a supervised learning mode is used to train or learn the events inherent in historical stock prices and volumes. Said event is a relationship between top/bottom periods of stock price and corresponding top/bottom volumes in a bull trend or a bear trend. In the present invention, the relationship, defined by the trained weights of neural network, is to determine whether if current volume fell within the volume range of the next bottom period when a top period is confirmed in a bear trend.

In the embodiment of the present invention, the historical data of stock price trends are composed of closing prices which include a daily price P_{D}(t_{D}), a weekly price P_{w}(t_{w}), and a monthly price P_{M}(t_{M}), wherein t_{D} is a daily unit, t_{w} is a weekly unit, and t_{M} is a monthly unit. The historical data of volume trends are composed of cumulative volumes which include a daily volume V_{D}(t_{D}), a weekly volume V_{w}(t_{w}), and a monthly volume V_{M}(t_{M}).

Therefore, the i-day moving average trend of daily price P_{D}(t_{D}) is represented by following Equ. (1).

$$\begin{matrix}{MAP}_{iD} ( {t}_{D} ) = \frac{{\sum }_{h = 0}^{i - 1} {P}_{D} ( {t}_{D} - h )}{i} \\ {MAP}_{lD} ( {t}_{D} ) = {P}_{D} ( {t}_{D} ) is obtained by Equ . ( 1 ) .\end{matrix} \qquad ( 1 )$$

The i-day moving average trend of daily volume V_{D}(t_{D}) is represented by following Equ. (2).

$$\begin{matrix}{MAV}_{iD} ( {t}_{D} ) = \frac{{\sum }_{h = 0}^{i - 1} {V}_{D} ( {t}_{D} - h )}{i} \\ {MAV}_{lD} ( {t}_{D} ) = {V}_{D} ( {t}_{D} ) is obtained by Equ . ( 2 ) .\end{matrix} \qquad ( 2 )$$

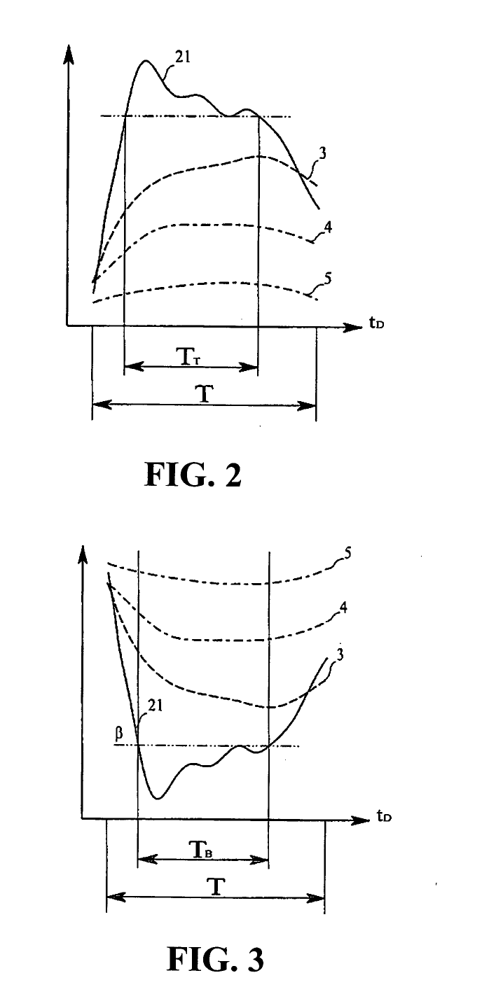

FIG. 2 illustrates a schematic diagram illustrating a top period of price in a bull trend and a corresponding top volume according to the present invention. The procedure to define a top period T_{T} of stock price trend and a top volume corresponding to the top period T_{T} according to the historical data P_{D}(t_{D}), P_{w}(t_{w}), P_{M}(t_{M}), V_{D}(t_{D}), V_{w}(t_{w}), V_{M}(t_{M}), MAP_{iD}(t_{D}) and MAV_{iD}(t_{D}) of said stock market information comprises the following steps:
a) Based on the i-day moving average trend MAP_{iD}(t_{D}), get a time period T on a time axis t_{D}, wherein the lines of the trends MAP_{72D} 3, MAP₆ₘ 4, or MAP_{12M} 5 are concave curves within the time period T; that is,
   MAP_{72D}={t_{D}|Zₘₐₓ=maxMAP_{72D}(t_{D}), t_{D} is not an end of T, t_{D}∈T}
   MAP_{6M}={t_{M}|Zₘₐₓ=maxMAP_{6M}(t_{M}), t_{M} is not an end of T, t_{M}∈T}
   MAP_{12M}={t_{M}|Zₘₐₓ=maxMAP_{12M}(t_{M}), t_{M} is not an end of T, t_{M}∈T} (3)
   And, the i-day moving average trend MAP_{iD}(t_{D}) has at least one local maximum Zₘ and at least one local minimum zₙ, and the absolute maximum Zₘₐₓ is one of local maximums Zₘ; that is,
   MAP_{iD}={t_{D},m,n|Zₘ=local_maxMAP_{iD}(t_{D}) and Zₙ=local_minMAP_{iD}(t_{D}), t_{D}∈T} (4)
b) determine a value a to obtain a continuous time period T_{T} such that MAP_{iD}(t_{D})≧α [symbol] t_{D}∈T_{T} and MAP_{iD}(t_{D})<α [symbol] t_{D}∉T_{T}, and the value is selected from one of local minimums Zₙ; that is,
   MAP_{iD}={t_{D},n|∃α,T_{T}MAP_{iD}(t_{D})≦ [symbol] t_{D}∈T_{T} and MAP_{iD}(t_{D})<α [symbol] t_{D}∉T_{T} and α∈zₙ} (5)
   The time period T_{T} is thus a top period of stock price trend.
c) obtain a top volume corresponding to the top period T_{T} according to the results of step b); that is,
   MAV_{iD}={t_{D}|MAV_{iD}(t_{D}), t_{D}∈T_{T}} (6)

According to the preferred embodiment of the invention, in the step a) of the procedure, the time period T could be selected from half-year to one year, or selected from 7 months to 12 months, or perfectly selected from 30 weeks to 46 weeks; the i-day moving average trend MAP_{iD}(t_{D}) is perfectly selected from MAP_{3D} [symbol] MAP_{6D} [symbol] MAP_{12D} and MAP_{24D}. In the step b) of the procedure, the continuous time period T_{T} is obtained in a range from 7 days to 21 days, or perfectly about two weeks. Thus, a top period T_{T} of stock price trend and a corresponding top volume 12 are determined.

FIG. 3 illustrates a schematic diagram illustrating a bottom period of price in a bear trend and a corresponding bottom volume according to the present invention. The procedure to define a bottom period T_{B} of stock price trend and a bottom volume 13 corresponding to the bottom period T_{B} according to the historical data P_{D}(t_{D}), P_{w}(t_{w}), P_{M}(t_{M}), V_{D}(t_{D}), V_{w}(t_{w}), V_{M}(t_{M}), MAP_{iD}(t_{D}) and MAV_{iD}(t_{D}) of said stock market information comprises the following steps:
a) Based on the i-day moving average trend MAP_{iD}(t_{D}), get a time period T on a time axis t_{D}, wherein the lines of the trends MAP_{72D} 3, MAP₆ₘ 4, or MAP_{12M} 5 are convex curves within the time period T; that is,
   MAP_{72D}={t_{D}|Zₘᵢₙ=minMAP_{72D}(t_{D}), t_{D} is not an end of T, t_{D}∈T}
   MAP_{6M}={t_{M}|Zₘₐₓ=maxMAP_{6M}(t_{M}), t_{M} is not an end of T, t_{M}∈T}
   MAP_{12M}={t_{M}|Zₘᵢₙ=minMAP_{12M}(t_{M}), t_{M} is not an end of T, t_{M}∈T} (7)
   And, the i-day moving average trend MAP_{iD}(t_{D}) has at least one local maximum Zₘ and at least one local minimum zₙ, and the absolute minimum Zₘᵢₙ is one of local minimums zₙ; that is,
   MAP_{iD}={t_{D},m,n|Zₘ=local_maxMAP_{iD}(t_{D}) and Zₙ=local_minMAP_{iD}(t_{D}), t_{D}∈T} (8)
b) determine a value β to obtain a continuous time period T_{B} such that MAP_{iD}(t_{D})≦β [symbol] t_{D}∈T_{B} and MAP_{iD}(t_{D})<β [symbol] t_{D}∉T_{B}, and the value is selected from one of local minimums zₙ; that is,
   MAP_{iD}={t_{D},m|∃β, T_{T}MAP_{iD}(t_{D})≦β [symbol] t_{D}∈T_{B} and MAP_{iD}(t_{D})<β [symbol] t_{D}∉T_{B} and βzₘ} (9)
   The time period TB is thus a bottom period of stock price trend.
c) obtain a top volume corresponding to the bottom period T_{B} according to the results of step b); that is,
   MAV_{iD}={t_{D}|MAV_{iD}(t_{D}), t_{D}∈T_{B}} (10)

According to the preferred embodiment of the invention, in the step a) of the procedure above, the time period T could be selected from half-year to one year, or selected from 7 months to 12 months, or perfectly selected from 30 weeks to 46 weeks; the i-day moving average trend MAP_{iD}(t_{D}) is perfectly selected from MAP_{3D} [symbol] MAP_{6D} [symbol] MAP_{12D} and MAP_{24D}. In the step b) of the procedure, the continuous bottom period T_{B} is obtained in a range from 7 days to 21 days, or perfectly about two weeks. Thus, a bottom period T_{B} of stock price trend and a corresponding bottom volume 13 are determined.

First Embodiment

According to the procedures above, the present invention determines a plurality of top periods T_{T1}, T_{T2} . . . and a plurality of bottom periods T_{B1}, T_{B2} . . . on the time axis t_{D} of the historical data MAP_{iD} and MAV_{iD}. When the stock price is in a bear trend, that a top period T_{T} was confirmed on MAP_{iD}(t_{D}), a predetermined relationship presented by the following IF-THEN Rule 1 is used to determine whether a bear bottom in the bear trend appears to be the way current volume fell within a volume range defined by the historical correlation between the stock price and volume.

Rule 1

IF the stock price is in a bear trend after a top period T_{T} was confirmed,
THEN a bear bottom in the bear trend appears to be the way current volume fell within a volume range defined by a correlative ratio of the absolute maximum Zₘₐₓ on the top period T_{T} to the volume corresponding to the Zₘₐₓ.

In the AI-processing computer system or expert system implemented by the monitoring method of the present invention, the rule-based database will include the IF-THEN Rule 1 above. Because the precondition of IF-THEN Rule 1 is verified by an event that a top period T_{T} was confirmed, the absolute maximum Zₘₐₓ on the top period T_{T} and the volume corresponding to the Zₘₐₓ are well known. A predetermined Equ. (11) of the correlation between the stock price and volume is as follows.

$$\frac{\begin{matrix}the {Z}_{max} in \\ the top period {T}_{T}\end{matrix}}{current price} = g \frac{\begin{matrix}the volume corresponding \\ to the {Z}_{max}\end{matrix}}{current volume} \qquad ( 11 )$$

wherein g is a gray coefficient, the gray coefficient defined herein is a gray number. The value domain of a gray number is a real number. A gray number is a value at a interval or a value in a range, not one value. That is,
g=[a,b], g∈R
wherein a is the lower bound of gray coefficient g, and b is the upper bound of gray coefficient g.

Equ. (11) defines a gray relationship between “a ratio of the Zₘₐₓ in the top period T_{T} to current price” and “a ratio of the volume corresponding to the Zₘₐₓ to current volume”, which exists a gray coefficient g. Hence, the gray coefficient g is used for evaluating the volume range when a bear bottom in the bear trend appears. The present invention employs a neural network with supervised learning mode to learn the gray relationship. The neural network is trained by training events in a supervised learning manner, such as BP algorithm, etc. Each training event is found in the historical stock prices and volumes in the bear bottoms and defined by the following equation.

$$\frac{\begin{matrix}the {Z}_{max} in \\ the top period {T}_{T}\end{matrix}}{\begin{matrix}the price in \\ the next bear bottom\end{matrix}} = g \frac{\begin{matrix}the volume corresponding \\ to the {Z}_{max}\end{matrix}}{\begin{matrix}the corresponding volume \\ in that bear bottom\end{matrix}}$$

The above equation is rewritten as following

$$g = \frac{\begin{matrix}the {Z}_{max} in \\ the top period {T}_{T}\end{matrix}}{\begin{matrix}the price in \\ the next bear bottom\end{matrix}} \times \frac{\begin{matrix}the corresponding volume \\ in that bear bottom\end{matrix}}{\begin{matrix}the volume corresponding \\ to the {Z}_{max}\end{matrix}}$$

obtaining the following equation

$$\begin{matrix}g = \frac{{Z}_{max}}{{MAP}_{iD} ( {t}_{D} )} \times \frac{{MAV}_{iD} ( {t}_{D} )}{{MAV}_{iD} ( {t}_{D max} )} , & & {t}_{D} ∈ {T}_{B}\end{matrix} \qquad ( 12 )$$

wherein MAV_{iD}(t_{Dmax}) is the volume corresponding to the Zₘₐₓ, the gray coefficient g in Equ. (12) is obtained from each training event.

If the precondition “a top period T_{T} was confirmed” of the IF-THEN Rule 1 is true, the training events for the neural network occur in the bear trend. On the time axis t_{D} of MAP_{iD}(t_{D}), Each training event that is a correlation for a top period T_{T} to the next bear bottom T_{B} is represented as
E:(T_{T}→T_{B})

The training data pair of each training event is defined as
[Input Pattern]:[Output Pattern]

$$\begin{matrix}⇒ [ \frac{{Z}_{max}}{{MAP}_{iD} ( {t}_{D} )} ] : [ g ] & & {t}_{D} ∈ {T}_{B}\end{matrix} \qquad ( 13 )$$

The output value of gray coefficient g in the training data pair is obtained by Equ. (12). Therefore, after the neural network is trained by training events E in the historical data in the stock market information, the neural network obtains a trained weights to define the correlation in the IF-THEN Rule 1. On the other words, the neural network can obtain an evaluated gray coefficient ĝ by the trained weights for adapting the Euq.

(11). The upper bound \hat{b} and the lower bound â of gray coefficient ĝ are obtained from a range of output values calculated by the trained weights and the input patterns.

Hence, the system of the present invention is implemented as an AI system. If a top period T_{T} is confirmed, the stock price is in a bear trend. Based on the above IF-THEN Rule 1 built in the knowledge base, the system implemented by the monitoring method of the present invention traces and monitors the variation of the daily price trend MAP_{iD}(t_{D}), and determines whether the next bear bottom in the bear trend appears to be the way the current volume fell within a volume range defined by the gray coefficient ĝ obtained by the trained neural network.

In this first embodiment of the present invention, the gray coefficient ĝ is obtained by the trained neural network, that is ĝ=[â,\hat{b}]. Equ. (11) is rewritten as

$$\begin{matrix}\frac{{Z}_{max}}{{P}_{D} ( t )} = g \frac{{V}_{D} ( {t}_{D max} )}{{V}_{D} ( t )} \\ ∴ {V}_{D} ( t ) = g \frac{{P}_{D} ( t )}{{Z}_{max}} {V}_{D} ( {t}_{D max} )\end{matrix} \qquad ( 14 )$$

wherein V_{D}(t_{Dmax}) is the corresponding volume. The gray coefficient g in Equ. (14) is replaced by the gray coefficient ĝ. Thus, the obtained volume V_{D}(t) is also a gray number. That is

$${V}_{D} ( t ) = [ \hat{a} \frac{{P}_{D} ( t )}{{Z}_{max}} {V}_{D} ( {t}_{D max} ) , \hat{b} \frac{{P}_{D} ( t )}{{Z}_{max}} {V}_{D} ( {t}_{D max} ) ] \qquad ( 15 )$$

Therefore, by determining whether the current volume fell within a volume range obtained by Equ. (15), the present invention acquaints the next bear bottom appears in the bear trend.

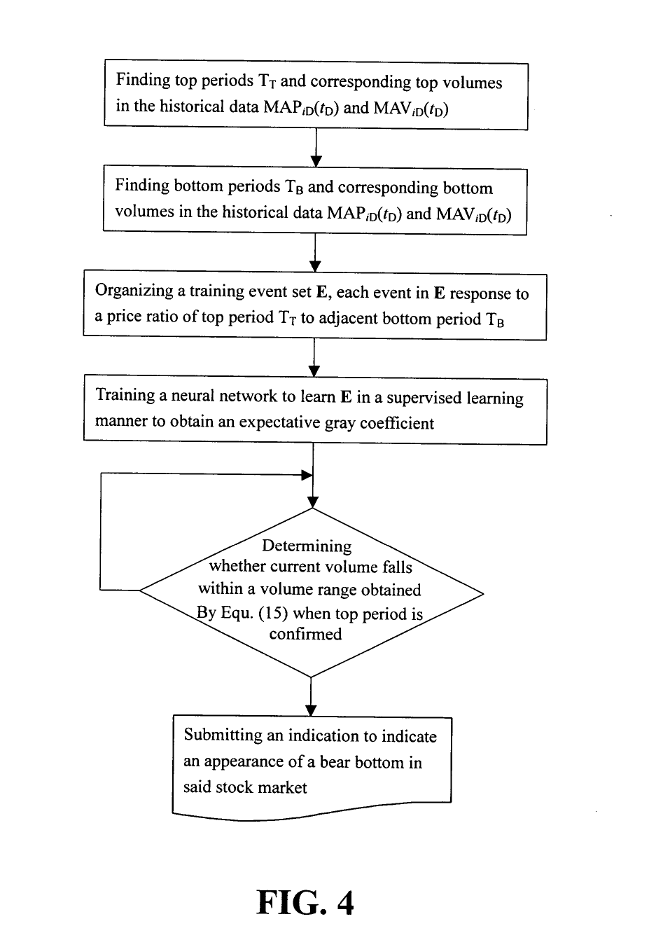

FIG. 4 shows a flowchart of the first embodiment of the present invention. The computer-implemented method for monitoring stock market information with investment risk, comprising the steps of:
finding a first data set comprising a top period T_{T} and a corresponding top volume in the historical data MAP_{iD}(t_{D}) and MAV_{iD}(t_{D}) of said stock market information, as shown in FIG. 2, the price curve and the volume curve in a top period T_{T} are represented by Equ. (5) and (6), respectively;
finding a second data set comprising a bottom period T_{B} and a corresponding bottom volume in the historical data MAP_{iD}(t_{D}) and MAV_{iD}(t_{D}) of said stock market information, as shown in FIG. 3, the price curve and the volume curve in a bottom period T_{B} are represented by Equ. (9) and (10), respectively;
organizing a training event set E from said first data set and said second data set, each training event E in said training event set E comprising a training pair response to a price ratio of said top period T_{T} to adjacent bottom period T_{B};
training a neural network to learn said training event set E in a supervised learning manner to obtain an expectative gray coefficient ĝ=[â,\hat{b}];
according to Equ. (11), determining whether current volume falls within a volume range obtained by Equ. (15) defined by said gray coefficient ĝ=[â,\hat{b}] when said top period T_{T} is confirmed on current MAP_{iD}(t_{D}); and
submitting an indication to indicate an appearance of a bear bottom in said stock market if current volume fell within said volume range.
   Second Embodiment

According to the procedures above, the present invention determines a plurality of top periods T_{T1}, T_{T2} . . . and a plurality of bottom periods T_{B1}, T_{B2} . . . on the time axis t_{D} of the historical data MAP_{iD} and MAV_{iD}. When the stock price is in a bull trend, that a bottom period T_{B} was confirmed on MAP_{iD}(t_{D}), a predetermined relationship presented by the following IF-THEN Rule 2 is used to determine whether a bull top in the bull trend appears to be the way current volume fell within a volume range defined by the historical correlation between the stock price and volume.

Rule 2

IF the stock price is in a bull trend after a bottom period TB was confirmed,
THEN a bull top in the bull trend appears to be the way current volume fell within a volume range defined by a correlative ratio of the absolute Zₘᵢₙ on the bottom period T_{B} to the volume corresponding to the Zₘᵢₙ.

In the AI-processing computer system or expert system implemented by the monitoring method of the present invention, the rule-based database will include the IF-THEN Rule 2 above. Because the precondition of IF-THEN Rule 2 is verified by an event that a bottom period T_{B} was confirmed, the absolute minimum Zₘᵢₙ on the bottom period T_{B} and the volume corresponding to the Zₘᵢₙ are well known. A predetermined Equ. (16) of the correlation between the stock price and volume is as follows.

$$\frac{current price}{\begin{matrix}the {Z}_{min} in the \\ bottom period {T}_{B}\end{matrix}} = g \frac{current volume}{\begin{matrix}the volume \\ corresponding to the {Z}_{min}\end{matrix}} \qquad ( 16 )$$

wherein g is a gray coefficient, the gray coefficient defined herein is a gray number. The value domain of a gray number is a real number. A gray number is a value at a interval or a value in a range, not one value. That is,
g=[a,b], g∈R
wherein a is the lower bound of gray coefficient g, and b is the upper bound of gray coefficient g.

Equ. (16) defines a gray relationship between “a ratio of current price to the Zₘᵢₙ in the bottom period T_{B}” and “a ratio of current volume to the volume corresponding to the Zₘᵢₙ”, which exists a gray coefficient g. Hence, the gray coefficient g is used for evaluating the volume range when a bull top in the bull trend appears.

The present invention employs a neural network with supervised learning mode to learn the gray relationship. The neural network is trained by training events in a supervised learning manner, such as BP algorithm, etc. Each training event is found in the historical stock prices and volumes in the bull top and defined by the following equation.

$$\frac{the price in the next bull top}{the {Z}_{min} in the bottom period {T}_{B}} = g \frac{the corresponding volume in that bull top}{the volume corresponding to the {Z}_{min}}$$

The above equation is rewritten as following

$$g = \frac{the price in the next bull top}{the {Z}_{min} in the bottom period {T}_{B}} \times \frac{the volume corresponding to the {Z}_{min}}{the corresponding volume in that bull top}$$

obtaining the following equation

$$g = \frac{{MAP}_{iD} ( {t}_{D} )}{{Z}_{min}} \times \frac{{MAV}_{iD} ( {t}_{Dmin} )}{{MAV}_{iD} ( {t}_{D} )} , {t}_{D} ∈ {T}_{T} \qquad ( 17 )$$

wherein MAV_{iD}(t_{Dmin}) is the volume corresponding to the Zₘᵢₙ, the gray coefficient g in Equ. (17) is obtained from each training event.

If the precondition “a bottom period T_{B} was confirmed” of the IF-THEN Rule 2 is true, the training events for the neural network occur in the bear trend. On the time axis t_{D} of MAP_{iD}(t_{D}), Each training event that is a correlation for a bottom period TB to the next bull top T_{T} is represented as
E:(T_{B}→T_{T})

The training data pair of each training event is defined as
[Input Pattern]: [Output Pattern]

$$⇒ [ \frac{{MAP}_{iD} ( {t}_{D} )}{{Z}_{min}} ] : [ g ] {t}_{D} ∈ {T}_{T} \qquad ( 18 )$$

The output value of gray coefficient g in the training data pair is obtained by Equ. (17). Therefore, after the neural network learns training events E in the historical data in the stock market information, the neural network obtains a trained weights to define the correlation in the IF-THEN Rule 2. On the other words, the neural network can obtain an evaluated gray coefficient g by the trained weights for adapting the Euq.

(16). The upper bound \hat{b} and the lower bound â of gray coefficient ĝ are obtained from a range of output values calculated by the trained weights and the input patterns.

Hence, the system of the present invention is implemented as an AI system. If a bottom period T_{B} is confirmed, the stock price is in a bull trend. Based on the above IF-THEN Rule 2 built in the knowledge base, the system implemented by the monitoring method of the present invention traces and monitors the variation of the daily price trend MAP_{iD}(t_{D}), and determines whether the next bull top in the bull trend appears to be the way the current volume fell within a volume range defined by the gray coefficient ĝ obtained by the trained neural network.

In this second embodiment of the present invention, the gray coefficient ĝ is obtained by the trained neural network, that is ĝ=[â,\hat{b}]. Equ. (16) is rewritten as

$$\frac{{P}_{D} ( t )}{{Z}_{min}} = g \frac{{V}_{D} ( t )}{{V}_{D} ( {t}_{D min} )} \\ ∴ {V}_{D} ( t ) = \frac{1}{g} \frac{{P}_{D} ( t )}{{Z}_{min}} {V}_{D} ( {t}_{D min} ) \qquad ( 19 )$$

wherein V_{D}(t_{Dmin}) is the corresponding volume. The gray coefficient g in Equ. (19) is replaced by the gray coefficient ĝ. Thus, the obtained volume V_{D}(t) is also a gray number. That is

$${V}_{D} ( t ) = [ \frac{1}{\hat{b}} \frac{{P}_{D} ( t )}{{Z}_{min}} {V}_{D} ( {t}_{D min} ) , \frac{1}{\hat{a}} \frac{{P}_{D} ( t )}{{Z}_{min}} {V}_{D} ( {t}_{D min} ) ] \qquad ( 20 )$$

Therefore, by determining whether the current volume fell within a volume range obtained by Equ. (20), the present invention acquaints the next bull top appears in the bull trend.

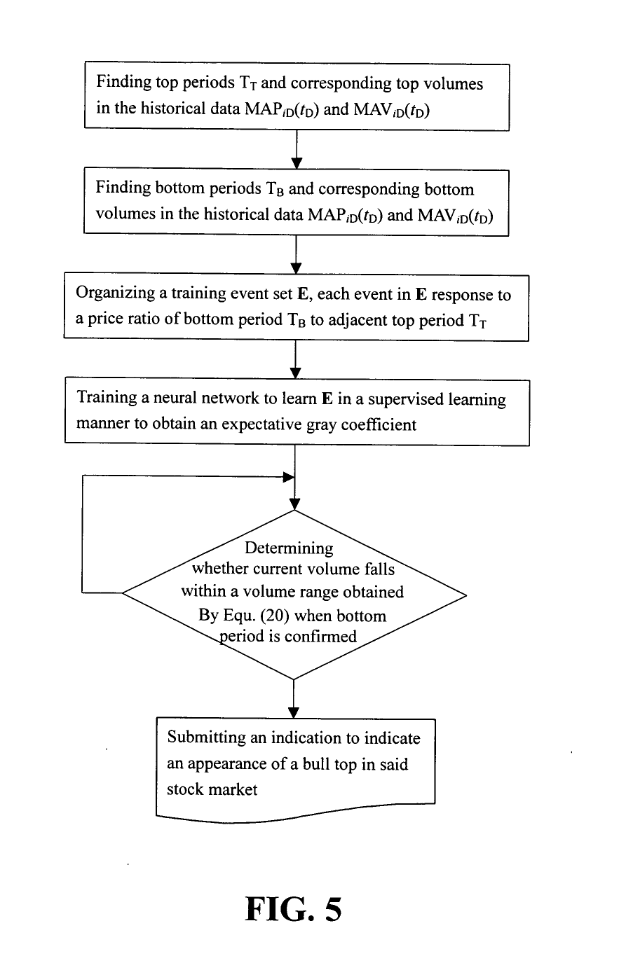

FIG. 5 shows a flowchart of the second embodiment of the present invention. The computer-implemented method for monitoring stock market information with investment risk, comprising the steps of:
finding a first data set comprising a top period T_{T} and a corresponding top volume in the historical data MAP_{iD}(t_{D}) and MAV_{iD}(t_{D}) of said stock market information, as shown in FIG. 2, the price curve and the volume curve in a top period T_{T} are represented by Equ. (5) and (6), respectively;
finding a second data set comprising a bottom period T_{B} and a corresponding bottom volume in the historical data MAP_{iD}(t_{D}) and MAV_{iD}(t_{D}) of said stock market information, as shown in FIG. 3, the price curve and the volume curve in a bottom period T_{B} are represented by Equ. (9) and (10), respectively;
organizing a training event set E from said first data set and said second data set, each training event E in said training event set E comprising a training pair response to a price ratio of said bottom period T_{B} to adjacent top period T_{T};
training a neural network to learn said training event set E in a supervised learning manner to obtain an expectative gray coefficient ĝ=[â,\hat{b}];
according to Equ. (16), determining whether current volume falls within a volume range obtained by Equ. (20) defined by said gray coefficient ĝ=[â,\hat{b}] when said bottom period T_{B} is confirmed on current MAP_{iD}(t_{D}); and
submitting an indication to indicate an appearance of a bull top in said stock market if current volume fell within said volume range.

1. A computer-implemented method for monitoring stock market information with investment risk, comprising the steps of:
finding a first data set comprising a top period T_{T} and a corresponding top volume in the historical data MAP_{iD}(t_{D}) and MAV_{iD}(t_{D}) of said stock market information;
finding a second data set comprising a bottom period T_{B} and a corresponding bottom volume in the historical data MAP_{iD}(t_{D}) and MAV_{iD}(t_{D}) of said stock market information;
organizing a training event set E from said first data set and said second data set, each training event E in said training event set E comprising a training pair response to a price ratio of said top period T_{T} to adjacent bottom period T_{B};
training a neural network to learn said training event set E in a supervised learning manner to obtain a gray coefficient ĝ=[â,\hat{b}];
determining whether current volume falls within a volume range defined by said gray coefficient ĝ=[â,\hat{b}] when said top period T_{T} is confirmed on current MAP_{iD}(t_{D}); and
submitting an indication to indicate an appearance of a bear bottom in said stock market if current volume fell within said volume range.

2. A computer-implemented method for monitoring stock market information with investment risk, comprising the steps of:
finding a first data set comprising a top period T_{T} and a corresponding top volume in the historical data MAP_{iD}(t_{D}) and MAV_{iD}(t_{D}) of said stock market information;
finding a second data set comprising a bottom period T_{B} and a corresponding bottom volume in the historical data MAP_{iD}(t_{D}) and MAV_{iD}(t_{D}) of said stock market information;
organizing a training event set E from said first data set and said second data set, each training event E in said training event set E comprising a training pair response to a price ratio of said bottom period T_{B} to adjacent top period T_{T};
training a neural network to learn said training event set E in a supervised learning manner to obtain a gray coefficient ĝ=[â,\hat{b}];
determining whether current volume falls within a volume range defined by said gray coefficient ĝ=[â,\hat{b}] when said bottom period T_{B} is confirmed on current MAP_{iD}(t_{D}); and
submitting an indication to indicate an appearance of a bull top in said stock market if current volume fell within said volume range.

3. The method of claim 1 or 2, wherein said MAP_{iD}(t_{D}) is i-day moving average trend of daily price P_{D}(t_{D}).

4. The method of claim 1 or 2, wherein said MAV_{iD}(t_{D}) is i-day moving average trend of daily volume V_{D}(t_{D}).

5. The method of claim 1 or 2, wherein the step of finding said first data set comprising said top period T_{T} and said corresponding top volume includes the steps of:
a) based on the trend of i day moving average MAP_{iD}(t_{D}), getting a time frame T on a time axis t_{D}, wherein MAP_{72D} or MAP₆ₘ or MAP_{12M} are convex curves and said MAP_{iD}(t_{D}) comprises at least a local maximum Zₘ and a local minimum zₙ in t_{D}∈T;
b) determining a value α to obtain said top period T_{T}, such
{MAP_{iD}|MAP_{iD}(t_{D})≧α [symbol] t_{D}∈T_{T} and MAP_{iD}(t_{D})<α [symbol] t_{D}∉T_{T}}
c) according to said top period T_{T}, obtaining said corresponding top volume from said MAV_{iD}(t_{D}).

6. The method of claim 5, wherein said time frame T is selected from 7 months to 12 months.

7. The method of claim 5, wherein said time frame T is perfectly selected from 30 weeks to 46 weeks.

8. The method of claim 5, wherein said i day moving average MAP_{iD}(t_{D}) is perfectly selected a group of MAP_{3D} [symbol] MAP_{6D} [symbol] MAP_{12D} or MAP_{24D}.

9. The method of claim 5, wherein said top period T_{T} is perfectly a period from 7 days to 21 days.

10. The method of claim 5, wherein said value α is one of local minimums zₙ in said step a).

11. The method of claim 1 or 2, wherein the step of finding said second data set comprising said bottom period T_{B} and said corresponding bottom volume includes the steps of:
a) based on the trend of i day moving average MAP_{iD}(t_{D}), getting a time frame T on a time axis t_{D}, wherein MAP_{72D} or MAP₆ₘ or MAP_{12M} are concave curves and said MAP_{iD}(t_{D}) comprises at least a local maximum Zₘ and a local minimum zₙ in t_{D}∈T;
b) determining a value β to obtain said bottom period T_{B}, such
{MAP_{iD}|MAP_{iD}(t_{D})≦β [symbol] t_{D}∈T_{B} and MAP_{iD}(t_{D})<β [symbol] t_{D}∉T_{B}}
c) according to said bottom period T_{B}, obtaining said corresponding bottom volume from said MAV_{iD}(t_{D}).

12. The method of claim 11, wherein said time frame T is selected from 7 months to 12 months.

13. The method of claim 11, wherein said time frame T is perfectly selected from 30 weeks to 46 weeks.

14. The method of claim 11, wherein said i day moving average MAP_{iD}(t_{D}) is perfectly selected a group of MAP_{3D} [symbol] MAP_{6D} [symbol] MAP_{12D} or MAP_{24D}.

15. The method of claim 11, wherein said top period T_{T} is perfectly a period from 7 days to 21 days.

16. The method of claim 11, wherein said value α is one of local maximums Zₘ in said step a).

17. The method of claim 1, wherein said indication represents current price fell into next bottom period T_{B}.

18. The method of claim 2, wherein said indication represents current price fell into next top period T_{T}.
